(19) United States
(12) Patent Application Publication
(10) Pub. No.: US 2024/0163264 A1
(43) Pub. Date: May 16, 2024

(54) REAL-TIME DATA ENCRYPTION/DECRYPTION SECURITY SYSTEM AND METHOD FOR NETWORK-BASED STORAGE

(71) Applicant: Penta Security Systems Inc., Seoul (KR)

(72) Inventors: Yun Seong KIM, Seoul (KR); Il Koo JUNG, Uijeongbu-si (KR)

(21) Appl. No.: 18/061,117

(22) Filed: Dec. 2, 2022

(30) Foreign Application Priority Data
Nov. 11, 2022 (KR) 10-2022-0150619

(51) Int. Cl. H04L 9/40

(52) U.S. Cl. CPC H04L 63/0435; H04L 63/102

(57) ABSTRACT

A real-time data encryption/decryption security system of network-based storage may comprise: a file input/output monitoring module monitoring initial write attempt to first data; an access control module determining whether a first location storing the first data is an encryption directory, determining whether the first location is in network-based storage, and determining whether an access right to the encryption directory is acquired; an encryption determination module determining whether the first data is initially generated in the network-based storage and determining identification data exists in an alternative data stream (ADS) of the first data; and an encryption/decryption module encrypting or decrypting the first data according to the presence of the identification data.

### CROSS-REFERENCE TO RELATED APPLICATIONS

This application claims priority to Korean Patent Application No. 10-2022-0150619, filed on Nov. 11, 2022 with the Korean Intellectual Property Office (KIPO), the entire contents of which are hereby incorporated by reference.

### BACKGROUND

### 1. Technical Field

The present disclosure relates to a security technology for performing real-time encryption/decryption of data, and more particularly, to a real-time data encryption/decryption security system and method for network-based storage.

### 2. Related Art

It is a recent trend to use network storage as a space for storing and sharing data in comparison to the only use of local server storage in the past. For example, network attached storage (NAS), a shared directory, or similar network storage means are being used. In order for such network-based storage to support easy access to data by multiple users with the simultaneous of various technologies, data security is one of the important factors required essentially.

In the case of network-based storage, which is usually installed in order for a large number of general users to access it, there is a high possibility of data leakage, and physical data storage theft or data acquisition through hacking by malicious users is likely to cause victims or confidential information leakage, so there is an urgent need for a method to encrypt and store data in the network-based storage effectively.

In the case where data is stored in an encrypted manner in network-based storage, although they can access the data, multiple general users cannot easily obtain plain data. That is, it is necessary to install an encryption/decryption security system to control access to data. However, it is not easy to apply the existing encryption solution of an API method, a plug-in method, an in-place method, or a combination thereof to network-based storage as a real-time data encryption/decryption security system.

Also, storing data in the network-based storage in an encrypted manner makes it possible, even when the physical storage is hijacked, to prevent the hijacker from acquiring plain data from the network-based storage and to control access to data from hacking or abnormal access attempted by unauthorized parties because the data was encrypted, resulting in protection of valuable data. As described above, there is a need for a real-time data encryption/decryption security method capable of protecting data stored in network-based storage while allowing a large number of users to use the data conveniently.

### SUMMARY

The present disclosure has been derived to solve the problems of conventional technology, and it is an object of the present disclosure to provide a real-time data encryption/decryption security system and method for network-based storage that is capable of protecting data from multiple users by encrypting key data through an encryption/decryption security system while allowing the users to access a shared directory and the key data according to their access rights.

It is another object of the present disclosure to provide a real-time data encryption/decryption security system and method for network-based storage that is capable of processing encrypted data in an identifiable manner by adding, when writing data, through an encryption/decryption system, to network-based storage to and from which multiple users can read or write data, encryption identification data to an alternate data stream (ADS) of the corresponding data.

It is still another object of the present disclosure to provide a real-time data encryption/decryption security system and method for network-based storage that is capable of recognizing the data written without going through an encryption/decryption security system as plain data and skipping encryption or decryption operation on the data recognized as plain data.

According to a first exemplary embodiment of the present disclosure, a real-time data encryption/decryption security system of network-based storage may comprise: a file input/output monitoring module monitoring initial write attempt to first data; an access control module determining whether a first location storing the first data is an encryption directory, determining whether the first location is in network-based storage, and determining whether an access right to the encryption directory is acquired; an encryption determination module determining whether the first data is initially generated in the network-based storage and determining identification data exists in an alternative data stream (ADS) of the first data; and an encryption/decryption module encrypting or decrypting the first data according to the presence of the identification data.

The access control module may detect the first location storing the first data and compare the first location with a pre-stored encryption directory list.

The identification data may comprise an identifier indicative of being encrypted or not or a code or an index indicative of an encryption type or level along with being encrypted or not.

The file input/output monitoring module may monitor access to a second data by an external application program in read mode or write mode.

The access control module may extract identity information about a file path of the second data, a process, and a user.

The access control module may determine whether a second location as a storage location of a file containing the second data is in the encryption directory based on the identity information and whether the second location is in the network-based storage.

The encryption determination module may access the ADS area of the second data to check the presence of encryption identification data.

The encryption/decryption module may perform encryption or decryption on the second data in read mode or write mode of the second data based on the presence of the encryption identification data.

The access control module may interwork with a policy database connected to a policy management module, wherein the policy management module may store an algorithm or a policy for adding the encryption identification data to the policy database.

The encryption/decryption module may interwork with a key database connected to an encryption-decryption key management module, wherein the encryption-decryption key management module may store an encryption-decryption key received from a key management server in the key database.

According to a second exemplary embodiment of the present disclosure, a real-time data encryption/decryption security method of network-based storage, which is executed by a processor, may comprise: monitoring an initial write attempt to first data; determining whether a first location storing the first data is an encryption directory; determining whether an access right to the encryption directory is acquired; determining whether the first location is in network-based storage; determining whether the first data is initially generated in the network-based storage; determining identification data exists in an alternative data stream (ADS) of the first data; and encrypting or decrypting the first data according to the presence of the identification data.

The determining whether the first location is an encryption directory may comprise detecting the first location storing the first data and comparing the first location with a pre-stored encryption directory list.

The identification data may comprise an identifier indicative of being encrypted or not or a code or an index indicative of an encryption type or level along with being encrypted or not.

The method may further comprise monitoring access to a second data by an external application program in read mode or write mode.

The method may further comprise extracting identity information about a file path of the second data, a process, and a user.

The method may further comprise: determining whether a second location as a storage location of a file containing the second data is in the encryption directory based on the identity information; and determining, when the second location is in the encryption directory, whether the second location is in the network-based storage.

The method may further comprise accessing, when the second location is in the network-based storage, the ADS area of the second data to check presence of encryption identification data.

The method may further comprise performing encryption or decryption on the second data in read mode or write mode of the second data based on the presence of the encryption identification data.

According to a third exemplary embodiment of the present disclosure, a real-time data encryption/decryption security system may comprise: a memory storing at least one program instruction for a real-time data encryption/decryption security method of network-based storage; and a processor connected to the memory to execute the at least one program instruction, wherein the processor executes the at least one program instruction to monitor an initial write attempt to first data, determine whether a first location storing the first data is an encryption directory, determine whether the first location is in network-based storage, determine whether the first data is initially generated in the network-based storage, determine identification data exists in an alternative data stream (ADS) of the first data, and encrypt or decrypt the first data according to the presence of the identification data.

The processor may further execute to monitor access to a second data by an external application program in read mode or write mode, extract identity information about a file path of the second data, a process, and a user, determine whether a second location as a storage location of a file containing the second data is in the encryption directory based on the identity information, determine, when the second location is in the encryption directory, whether second location is in the network-based storage, access, when the second location is in the network-based storage, the ADS area of the second data to check presence of encryption identification data, and perform encryption or decryption on the second data in read mode or write mode of the second data based on the presence of the encryption identification data.

According to the present disclosure, it is possible to process encrypted data in an identifiable manner by adding, when writing data, through an encryption/decryption system, to network-based storage to and from which multiple users can read or write data, encryption identification data to an alternate data stream (ADS) of the corresponding data, which makes it possible to protect data by preventing the data from being exposed as plain data to multiple users attempting access thereto unless the users access the encrypted data through an encryption security system and to secure the safety of the data even when the data is physically stolen or leaked by unauthorized users or hackers because due to no encryption data in the data itself.

According to the present disclosure, it is also possible to recognize the data written without going through an encryption/decryption security system as plain data and skip encryption or decryption operation on the data recognized as plain data, which makes it possible to improve data processing speed while allowing application programs running on a local server to easily access network-based storage according to their rights.

According to the present disclosure, it is also possible, when having an access right to write on encryption target data, to generate an encryption target identifier and encrypt the data in real time, which makes it possible to facilitate providing a service by making a quick and reliable determination, when reading data, on whether the data is encrypted.

### BRIEF DESCRIPTION OF DRAWINGS

FIG. 1 is a conceptual diagram illustrating a real-time data encryption/decryption security system for network-based storage according to an embodiment of the present disclosure.

FIG. 2 is a flowchart illustrating a data writing procedure that can be employed in the security system of FIG. 1.

FIG. 3 is a flowchart illustrating a data access procedure that can be employed in the security system of FIG. 1.

FIG. 4 is a signal flow diagram illustrating an encryption-decryption key management procedure that can be employed in the security system of FIG. 1.

FIG. 5 is a block diagram illustrating a new technology file system (NTFS) file format having an alternate data stream (ADS) that can be employed in the security system of FIG. 1.

FIG. 6 is a schematic block diagram illustrating a security system according to another embodiment of the present disclosure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

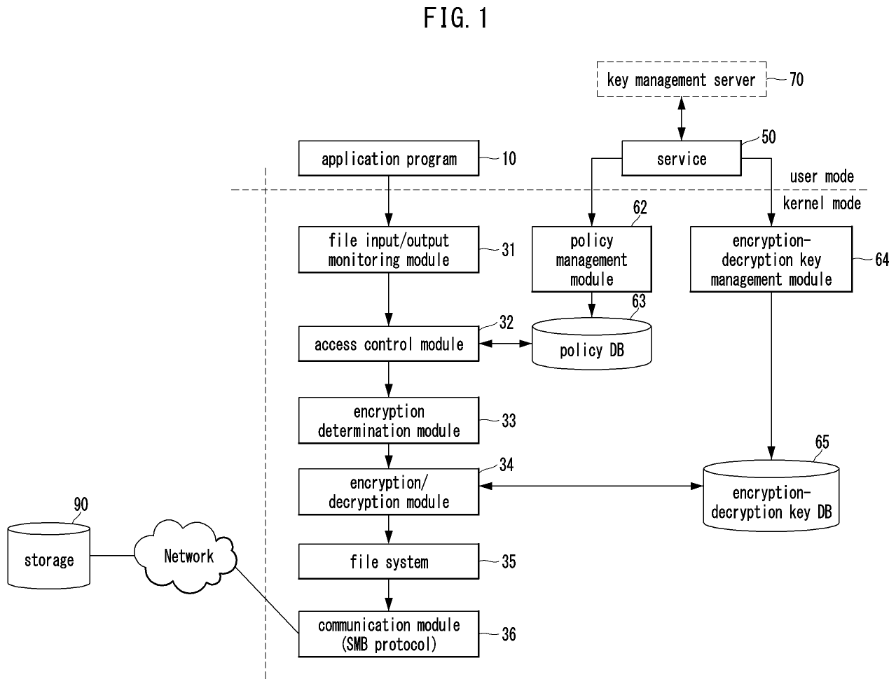

FIG. 1 is a conceptual diagram illustrating a real-time data encryption/decryption security system (hereinafter simply referred to as ‘real-time data encryption/decryption security system’ or ‘security system’) for network-based storage according to an embodiment of the present disclosure.

With reference to FIG. 1, the security system may interwork with the key management server 70 through the service 50 and may be configured to perform real-time data encryption/decryption security procedure on the data being written or read to or from the network-based storage 90 via a file input/output monitoring module 31, an access control module 32, an encryption determination module 33, an encryption/decryption module 34, a policy management module 62, a policy database (DB) 63, an encryption-decryption key management module 64, and an encryption-decryption key database (DB) 65.

In addition, the security system may further include a file system 35 and a communication module 36 and may be mounted on a computing device having at least one processor. The file system 35 may refer to a storage system or an organization system allowing the computing device to retrieve and access files or data. In addition, the communication module 36 may include a sub-communication system supporting a file-sharing function such as a server message block (SMB) protocol.

In detail, the service 50 may be configured to request an access management policy and an encryption-decryption key from the key management server 70 according to a predetermined operation procedure in response to an application program 10 accessing specific data, receive the encryption-decryption key and a first algorithm for the access management policy from the key management server 70, transmit the first algorithm to the policy management module 62, and transmit the encryption-decryption key to the encryption-decryption key management module 64.

The service 50 may operate in a user mode of the computing device and may be referred to as a service module or a service interface. The service 50 may also be referred to as a key management server interworking service, encryption-decryption key management service, or data encryption/decryption security service.

The file input/output monitoring module 31, the access control module 32, the encryption determination module 33, the encryption/decryption module 34, the policy management module 62, and the encryption key management module 64 may operate in a kernel mode of the computing device functioning as a security system.

The file input/output monitoring module 31 may monitor whether the application program 10 running on the computing device or on an external computing device connected through a network accesses specific data. When the application program 10 accesses specific data, the file input/output monitoring module 31 may transmit the corresponding event (hereinafter ‘first event’) information to the access control unit 32. The file input/output monitoring module 31 may also monitor whether an external application program accesses specific data in a read mode or a write mode.

Meanwhile, the policy management module 62 may receive the first algorithm from the service 50 and store the first algorithm in the policy DB 63. Here, the first algorithm may include an algorithm for decrypting the encrypted encryption-decryption key.

The policy management module 62 may store an algorithm or policy for adding encryption identification data in the policy DB 63. In addition, the policy management module 62 may store a rule or policy for creating, when an authorized user initially creates data in data writing mode, identification data in the ADS area of the data for encryption identification and skipping encryption/decryption on the data stored without using the encryption/decryption security system to prevent the data from being corrupted.

Also, the policy management module 62 may store a rule or policy for controlling access to specific user or a specific data in the policy DB 63. Here, the rule or policy may be preset and stored or determined by real-time user input through a user interface. The user interface for configuring the rule or policy may include an output interface providing information on whether the data is supposed to be encrypted or not based on a predetermined user whitelist or information on data satisfying a predetermined condition. The output interface may be configured to generate a display screen or speaker output with light, sound, or the like.

The access control module 32 may determine whether a location (hereinafter referred to as ‘first location’) in which specific data (hereinafter referred to as ‘first data’) is stored is an encryption directory and whether the first location is network-based storage. The access control module 32 may also be configured to detect the first location where the first data is stored and compare the detected first location with a pre-stored encryption directory list. The access control module 32 may determine whether a user or a corresponding user terminal accessing the first data has an access right to the encryption directory.

In addition, the access control module 32 may extract, when an external application program accesses specific data (hereinafter referred to as ‘second data’) in read mode or write mode, the file path of the second data and identification information for the process and user and then determine, on the basis of the extracted identification information, whether a storage location (hereinafter, referred to as a ‘second location’) of the file containing the second data is in the encryption directory and whether the second location is network-based storage.

The access control module 32 may also be configured to acquire, after acquiring the storage path of the data indicated by the first event information and acquiring the user based on the user information, an execution process for encryption/decryption of the data or control access to the user or data.

The access control module 32 may include a file path acquisition unit, a user acquisition unit, an execution process acquisition unit, and an access control unit. Here, the access control module 32 may interwork with the policy DB 63 to grant or control access to users or data.

The encryption determination module 33 may determine whether the first data is initially generated in the network-based storage and access the alternative data stream (ADS) area of the first data to check whether identification data exists. The identification data may include an identifier indicating whether encryption is performed or a code or index indicative of an encryption type or level along with whether encryption is performed and may also be referred to as encryption identification data.

The encryption determination module 33 may also determine whether the data is encrypted based on user information, data access rights, and data management policies received from the access control module 32. The encryption determination module 33 may transmit, when data encryption is required, information on the corresponding encryption target data to the encryption/decryption module 34.

Meanwhile, the encryption-decryption key management module 64 may receive the encryption-decryption key from the service 50 and store the encryption-decryption key in the encryption-decryption key DB 65.

The encryption/decryption module 34 may interwork with the encryption-decryption key DB 65. The encryption/decryption module 34 may also perform, when the identification data exists in the ADS area of the first data, an action for a predefined differential security service such as encryption and decryption of the first data according to the definition of the identification data.

For example, the encryption/decryption module 34 may identify a user with access rights and encryption/decryption target data according to information, such as encryption identification data, from the encryption determination module 33 and perform encryption/decryption on the encryption/decryption target data.

The encryption/decryption module 34 may identify the encryption/decryption target data based on the context information of the encryption/decryption target data. The encryption/decryption module 34 may use the encryption-decryption key stored in the encryption-decryption key DB 65 for encryption/decryption of the encryption/decryption target file. The encryption/decryption module 34 may also encrypt and store the encryption target data, decrypt and output the decryption target data, and then perform a log procedure.

The file system 35 may write or read data encrypted and/or decrypted by the encryption/decryption module 34 to or from the network-based storage 90 through the communication module 36.

The network-based storage 90 is a device connected to a network to store data and may be configured to allow general users as well as authorized users to store and retrieve data. Network-based storage 90 may be referred to as storage, network-attached storage, or the like.

The key management server 70 may be configured to receive a request for and transmit a policy for data management or an encryption algorithm and an encryption-decryption key through a socket encryption communication connection to the service 50 or a computing device equipped with a service interface.

Although the description has been made of the embodiment of a configuration in which the policy management module 62 and the encryption-decryption key management module 64 separately manage the first algorithm and the encryption-decryption key, the present disclosure is not limited thereto, and the encryption-decryption key management module 64 may be configured to receive the first algorithm together with the encryption-decryption key from the service 50. In this case, the policy DB 63 and the encryption-decryption key DB 65 may be installed in a single database system.

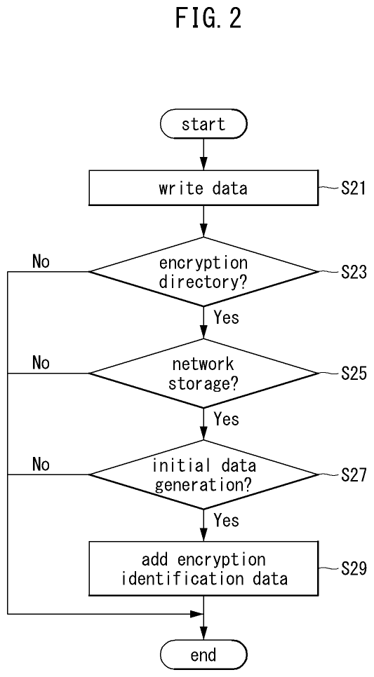

FIG. 2 is a flowchart illustrating a data writing procedure that can be employed in the security system of FIG. 1.

With reference to FIG. 2, when the user first attempts to write data to the network-based storage through an application program or service at step S21, the security system may perform a data write procedure according to a predetermined data write management policy.

First, the security system may determine at step S23 whether a location in which encryption target data is stored is an encryption directory. At this step, the security system may detect a location (hereinafter, ‘first location’) where the encryption target data is stored in the access control module and compare the data with the encryption directory list. Meanwhile, when the first location is not the encryption directory, the security system may provide the user terminal with a notification message notifying that the encryption condition is met and then terminate the procedure.

Next, as a result of the determination at the above determination step S23, when the first location is an encryption directory, the security system may determine at step S25 whether the first location or encryption directory is in the network-based storage via the access control module or the encryption determination module. On the other hand, when the first location is not the encryption directory, the security system may provide the user terminal with a notification message notifying that the encryption condition is met and then terminate the present procedure.

Meanwhile, as a result of the determination at the above determination step S23, when the first location is the encryption directory, the security system may selectively determine whether the corresponding user terminal has access to the encryption directory.

Next, as a result of the determination at the above determination step S25, if the first location or the encryption directory is in the network-based storage, the security system may determine at step S27 whether the encryption target data is initially generated through the encryption determination module. On the other hand, when the first location or the encryption directory is not in the network-based storage, the security system may provide the user terminal with a notification message informing that the encryption condition is met and then terminate the procedure.

Next, as a result of the determination at the above determination step S27, if the encryption target data is initially generated, the security system may add the encryption identification data to the encryption target data through the encryption/decryption module at step S29.

The encryption identification data may be added to an alternate data stream (ADS) area of the data. The ADS area is a type of data stream in the Windows new technology file system (NTFS). The encryption identification data may simply include an identifier indicating whether encryption is performed or may include a code or index indicating an encryption type or level in addition to the identifier.

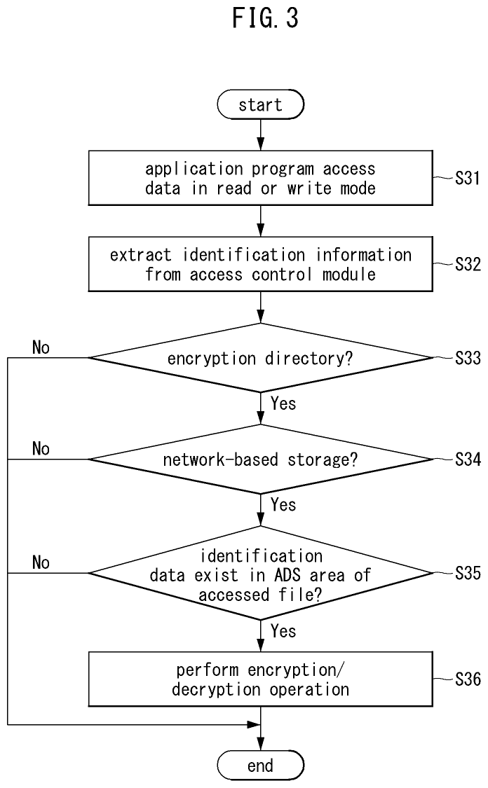

FIG. 3 is a flowchart illustrating a data access procedure that can be employed in the security system of FIG. 1.

With reference to FIG. 3, the security system may monitor at step S31 that the user terminal accesses specific data (hereinafter, ‘second data’) stored in the network-based storage via an application program in read mode or write mode.

When the application program accesses the second data in the read mode or the write mode, the security system may extract, at step S32, identification information such as the file path, process, and user of the second data from the access control module of the kernel file system.

Next, the security system may determine at step S33 whether the storage location of the file containing the second data (hereinafter ‘second location’) is in the encryption directory based on the extracted identification information.

Meanwhile, as a result of the determination at the above determination step S33, when the second location is the encryption directory, the security system may selectively determine whether the corresponding user terminal has access to the encryption directory.

Next, as a result of the determination at the above determination step S33, when the second location is an encryption directory, the security system may determine at step S34 whether the second location or encryption directory is in the network-based storage via the access control module or the encryption determination module.

Next, as a result of the determination in the above determination step S34, if the second location or the encryption directory is in the network-based storage, the security system may identify at step S35 whether the identification data exists in the ADS area of the second data. That is, the security system may access the ADS area of the second data to check whether the identification data, i.e., encryption identification data, exists in the ADS area.

Next, as a result of the determination at the above determination step S34, when the second data is a file encrypted with the encryption identification data, the security system may recognize the second data as an encrypted file and perform an encryption or decryption operation at step S36.

On the other hand, as a result of the determination at each of the above determination steps S33, S34, and S35, when the second location is not in an encryption directory or a network-based storage, or no identification data exists in the ADS area of the second data, the security system may output a predetermined alarm message and terminate the procedure.

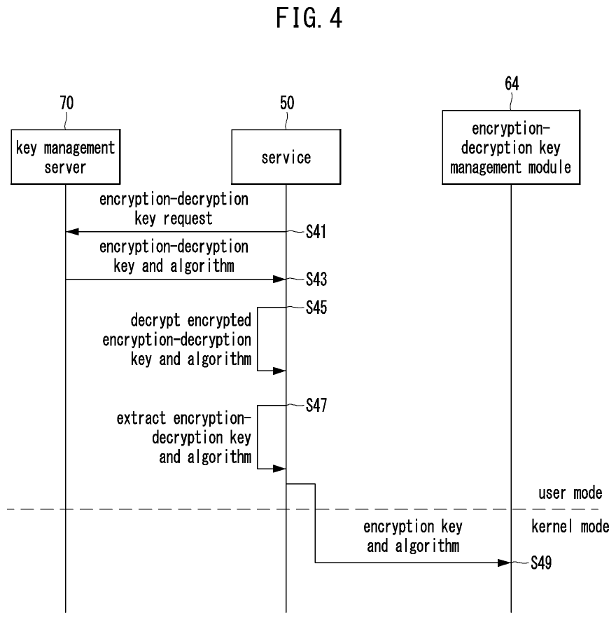

FIG. 4 is a signal flow diagram illustrating an encryption-decryption key management procedure that can be employed in the security system of FIG. 1.

With reference to FIG. 4, the security system may perform real-time data encryption/decryption security operation based on the encryption-decryption key management procedure of the service 50 and the encryption-decryption key management module 64 while interworking with the key management server 70.

In detail, for encryption-decryption key management, the security system may first request the encryption-decryption key from the key management server 70 in the user mode at step S41.

Next, it is possible to receive, at step S43, an algorithm for applying a rule or policy for encryption-decryption key management, e.g., first algorithm, together with the encryption-decryption key from the key management server 70.

Next, it is possible to decrypt the encrypted encryption-decryption key via the first algorithm at step S45.

Next, it is possible to extract the encryption-decryption key and the first algorithm in the user mode at step S47.

Next, the security system may transmit the extracted encryption-decryption key and the first algorithm to the encryption-decryption key management module in the kernel mode at step S49.

The encryption-decryption key and the first algorithm may be used when determining whether the storage location of the data is an encryption directory and/or a network-based storage in the real-time data encryption/decryption security process of the network-based storage and when encrypting or decrypting the corresponding data depending on the presence or absence of the encryption identification data in the ADS area of the data.

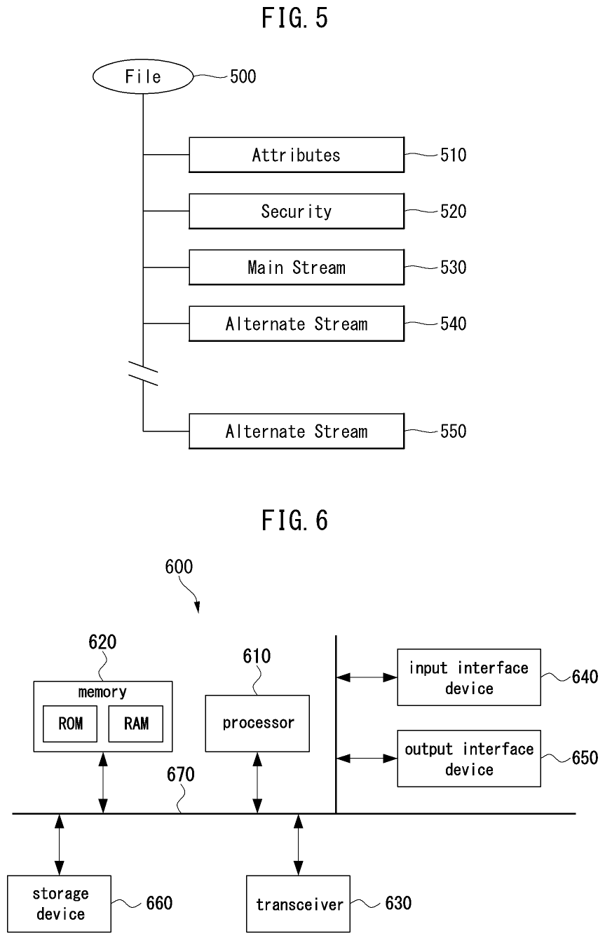

FIG. 5 is a block diagram illustrating a new technology file system (NTFS) file format having an alternate data stream (ADS) that can be employed in the security system of FIG. 1.

With reference to FIG. 5, a file 500 of NTFS that can be employed in the security system of the present embodiment may be represented by a name such as name.txt and may include a filed 510 for attributes, a field 520 for security, a field 530 for the main stream, a field 540 for the first alternate stream, and a field 550 for the nth alternate stream. Here, n is a natural number equal to or greater than 2.

All data on network-based storage formatted in NTFS format are assigned one or more data streams. In particular, one of the features of NTFS is that a file can contain multiple data streams.

The main stream 530 is an unnamed primary data stream that can be executed when double-clicking a file on a computing device or running the file from a command prompt.

Each of the plurality of alternate streams 540 and 550 is an alternate data stream (ADS) assigned a name so as to be easily distinguished from the unnamed primary data stream.

Using the ADS area or a means or component similar or identical in function thereto, it is possible to effectively identify encrypted data by adding encryption identification data to the encryption target data or the corresponding file.

Meanwhile, although the Windows versions after the Windows XP version prevents an execution file from being executed in the ADS area, in the present embodiment, adding the encryption identification data to the ADS area makes it possible to effectively distinguish between encrypted data and plain data in the network-based storage, thereby facilitating real-time data encryption/decryption process.

FIG. 6 is a schematic block diagram illustrating a security system according to another embodiment of the present disclosure.

With reference to FIG. 6, the security system 600 may include at least one processor 610, a memory 620, and a transceiver 630 connected to a network-based storage to perform communication. In addition, the security system 600 may further include an input interface device 640, an output interface device 650, and a storage device 660. Each of the components included in the security system 600 may be connected via a bus 670 to communicate with each other.

In addition, each of the components included in the security system 600 may be connected to the processor 610 as a center via an individual interface or bus other than the common bus 670. For example, the processor 610 may be connected to at least one of the memory 620, the transceiver 630, the input interface device 640, the output interface device 650, and the storage unit 660 via a dedicated interface.

The processor 610 may refer to a central processing unit (CPU), a graphics processing unit (GPU), or a dedicated processor on which the methods according to embodiments of the present disclosure are performed.

Each of the memory 620 and the storage device 660 may be configured as at least one of a volatile storage medium and a non-volatile storage medium. For example, the memory 620 may be configured as at least one of read-only memory (ROM) and random access memory (RAM).

The transceiver 630 may include a sub-communication system for communicating with a base station or a gateway of a wired network, a wireless network, a satellite network, and the like. The sub-communication system may be configured to support a wired and/or wireless communication protocol.

The input interface device 640 may include an input signal processing unit that maps, to a prestored instruction, or processes a signal input through at least one input means selected among input means such as a keyboard, a microphone, a touch pad, and a touch screen.

The output interface device 650 may include an output signal processing unit mapping, to a prestored signal form or level, or processing a signal output under the control of the processor 610 and at least one output means outputting a signal or information in the form of vibration or light according to a signal of the output signal processing unit. The at least one output means may include at least one selected among output means such as a speaker, a display device, a printer, an optical output device, and a vibration output device.

The processor 610 may execute program instructions stored in at least one of the memory 620 and the storage device 660. The processor 610 may perform a procedure of adding identification data to the encrypted data (refer to FIG. 2) and a procedure of reading or writing an encrypted file (refer to FIG. 3) according to program instructions. The program instructions may be configured to execute at least one instruction for implementing a procedure for adding identification data to the encrypted data and a procedure for reading or writing an encrypted file.

For example, the processor 610 may be configured to monitor the first data write attempt for specific data to network storage, determine whether the location (first location) where the encryption target data is stored is an encryption directory, determine whether the first location or encryption directory is network-based storage, determine whether the encryption target data is initially generated, and add encryption identification data to the ADS area of the initially generated data, via at least one instruction or a software module including at least one instruction, e.g., a file input/output monitoring module, an access control module, an encryption determination module, an encryption/decryption module, etc.

According to the above-described embodiments, it is possible to encrypt and protect data from a plurality of users who can access the network-based storage. That is, in a state where multiple users can access a shared directory and access key data, it is possible to protect data from multiple users by encrypting key data via an encryption/decryption security system. In addition, even when several users access encrypted data, it is possible to protect the data by preventing the acquisition of plain data unless it is accessed through the encryption/decryption security system. Moreover, even when data is physically stolen or leaked by an unauthorized user or hacker, it is possible to protect the data safely because there is no encryption-related data in the data itself.

According to the above-described embodiments, it is also possible to identify data written in the network-based storage. That is, in a network-based storage that allows multiple users to read and/or write data, it is possible to identify encrypted data and plaintext data effectively. In addition, it is possible to add, when data is written through the encryption/decryption security system, encryption identification data to the Alternate Data Stream (ADS) of the data to effectively recognize the encrypted data. In this case, when the data is written without going through the encryption/decryption security system, it is possible to identify the data as plain data without being encrypted and skip performing encryption or decryption operation thereon, resulting in improvement of the performance and efficiency of the security system.

According to the above-described embodiments, it is also possible to effectively manage data access rights and perform data encryption/decryption in network-based storage. That is, it is possible to configure access rights of application programs running on a user terminal or a local server to access network-based storage. In this case, when data attempted to be written by a local server with access rights is a data encryption target, it is possible to generate an encryption target identifier to encrypt the data in real-time. The encryption target identifier makes it possible to quickly and accurately determine, when reading data, whether the data is encrypted and, when accessing the corresponding data, whether to perform decryption on the data, which allows acquiring and providing plain data to the user terminal without damaging the corresponding file.

According to the above-described embodiments, it is also possible to effectively identify encrypted data through the encryption/decryption security system. That is, by creating and adding identification data to the ADS area for encryption identification at the time of initial data creation, it becomes possible to skip performing encryption/decryption on the data stored without using the encryption/decryption security system to prevent the data from being corrupted.

In particular, it is possible, when there is no encryption identification data corresponding to the data attempted to be read using the encryption/decryption security system, to perform a process to read the original data without performing the decryption function. It is also possible, when there is no encryption identification data in the ADS area of the data attempted to be written using the encryption/decryption security system, to perform the process of writing the plain data without performing the encryption function.

In addition, it is possible to effectively protect data by allowing the acquisition of the data as encrypted in the case of not using the encryption/decryption security system and by still allowing the acquisition of the data even in the case where an attempt is made to read data encrypted through the encryption/decryption security system from another personal computer (PC).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A real-time data encryption/decryption security system of network-based storage, the system comprising:
a file input/output monitoring module monitoring initial write attempt to first data;
an access control module determining whether a first location storing the first data is an encryption directory, determining whether the first location is in network-based storage, and determining whether an access right to the encryption directory is acquired;
an encryption determination module determining whether the first data is initially generated in the network-based storage and determining identification data exists in an alternative data stream (ADS) of the first data; and
an encryption/decryption module encrypting or decrypting the first data according to the presence of the identification data.

2. The system of claim 1, wherein the access control module detects the first location storing the first data and compares the first location with a pre-stored encryption directory list.

3. The system of claim 1, wherein the identification data comprises an identifier indicative of being encrypted or not or a code or an index indicative of an encryption type or level along with being encrypted or not.

4. The system of claim 1, wherein the file input/output monitoring module monitors access to a second data by an external application program in read mode or write mode.

5. The system of claim 4, wherein the access control module extracts identity information about a file path of the second data, a process, and a user.

6. The system of claim 5, wherein the access control module determines whether a second location as a storage location of a file containing the second data is in the encryption directory based on the identity information and whether the second location is in the network-based storage.

7. The system of claim 5, wherein the encryption determination module accesses the ADS area of the second data to check the presence of encryption identification data.

8. The system of claim 7, wherein the encryption/decryption module performs encryption or decryption on the second data in read mode or write mode of the second data based on the presence of the encryption identification data.

9. The system of claim 8, wherein the access control module interworks with a policy database connected to a policy management module,
wherein the policy management module stores an algorithm or a policy for adding the encryption identification data to the policy database.

10. The system of claim 9, wherein the encryption/decryption module interworks with a key database connected to an encryption-decryption key management module,
wherein the encryption-decryption key management module stores an encryption-decryption key received from a key management server in the key database.

11. A real-time data encryption/decryption security method of network-based storage, which is executed by a processor, the method comprising:
monitoring an initial write attempt to first data;
determining whether a first location storing the first data is an encryption directory;
determining whether an access right to the encryption directory is acquired;
determining whether the first location is in network-based storage;
determining whether the first data is initially generated in the network-based storage;
determining identification data exists in an alternative data stream (ADS) of the first data; and
encrypting or decrypting the first data according to the presence of the identification data.

12. The method of claim 11, wherein determining whether the first location is an encryption directory comprises detecting the first location storing the first data and comparing the first location with a pre-stored encryption directory list.

13. The method of claim 11, wherein the identification data comprises an identifier indicative of being encrypted or not or a code or an index indicative of an encryption type or level along with being encrypted or not.

14. The method of claim 11, further comprising monitoring access to a second data by an external application program in read mode or write mode.

15. The method of claim 14, further comprising extracting identity information about a file path of the second data, a process, and a user.

16. The method of claim 15, further comprising:
determining whether a second location as a storage location of a file containing the second data is in the encryption directory based on the identity information; and
determining, when the second location is in the encryption directory, whether the second location is in the network-based storage.

17. The method of claim 16, further comprising accessing, when the second location is in the network-based storage, the ADS area of the second data to check presence of encryption identification data.

18. The method of claim 17, further comprising performing encryption or decryption on the second data in read mode or write mode of the second data based on the presence of the encryption identification data.

19. A real-time data encryption/decryption security system comprising:
a memory storing at least one program instruction for a real-time data encryption/decryption security method of network-based storage; and
a processor connected to the memory to execute the at least one program instruction,
wherein the processor executes the at least one program instruction to monitor an initial write attempt to first data, determine whether a first location storing the first data is an encryption directory, determine whether the first location is in network-based storage, determine whether the first data is initially generated in the network-based storage, determine identification data exists in an alternative data stream (ADS) of the first data, and encrypt or decrypt the first data according to the presence of the identification data.

20. The system of claim 19, wherein the processor further executes to monitor access to a second data by an external application program in read mode or write mode, extract identity information about a file path of the second data, a process, and a user, determine whether a second location as a storage location of a file containing the second data is in the encryption directory based on the identity information, determine, when the second location is in the encryption directory, whether second location is in the network-based storage, access, when the second location is in the network-based storage, the ADS area of the second data to check presence of encryption identification data, and perform encryption or decryption on the second data in read mode or write mode of the second data based on the presence of the encryption identification data.
